(19) United States
(12) Patent Application Publication
(10) Pub. No.: US 2025/0266777 A1
(43) Pub. Date: Aug. 21, 2025

(54) ELECTRIC MOTOR CONTROLLER AND RELATED METHODS

(71) Applicant: SEMICONDUCTOR COMPONENTS INDUSTRIES, LLC, Scottsdale, AZ (US)

(72) Inventor: Jacques Jean BERTIN, Pocatello, ID (US)

(73) Assignee: SEMICONDUCTOR COMPONENTS INDUSTRIES, LLC, Scottsdale, AZ (US)

(21) Appl. No.: 18/924,731

(22) Filed: Oct. 23, 2024

Related U.S. Application Data
(60) Provisional application No. 63/556,246, filed on Feb. 21, 2024.

(51) Int. Cl. H02P 21/18; H02P 21/08; H02P 21/12; H02P 21/22

(52) U.S. Cl. CPC H02P 21/18; H02P 21/08; H02P 21/12; H02P 21/22; H02P 2203/05

(57) ABSTRACT

Electric motor controller and related methods. One example is method of controlling an electric motor, the method comprising: calculating, by a motor controller, setpoint Q-D signals based on a setpoint speed signal, the setpoint Q-D signals represent setpoint position of a magnetic field relative to a rotor of the electric motor; serially sending, by the motor controller, the setpoint Q-D signals to a field-oriented controller disposed within a distinct packaging from the motor controller; converting, by the field-oriented controller, the setpoint Q-D signals to setpoint α-β signals that represent setpoint position of the magnetic field relative to A stator of the electric motor; transforming, by the field-oriented controller, the setpoint α-β signals into setpoint voltage signals; and gating, by the field-oriented controller, an inverter based on the setpoint voltage signals.

### CROSS-REFERENCE TO RELATED APPLICATIONS

This application claims the benefit of U.S. Provisional Application No. 63/556,246 filed Feb. 21, 2024 and titled, “Sensored Field Oriented Control Signal Processing.” The provisional application is incorporated by reference herein as if reproduced in full below.

### BACKGROUND

Electric motor speed control plays an ever-increasing role in various industrial and consumer applications, ranging from household appliances to complex manufacturing systems. With the advent of electronic control systems, there has been a significant shift towards more sophisticated methods that utilize microcontrollers, sensors, and advanced algorithms to achieve precise and efficient speed regulation. The electronic systems not only enhance performance and reliability, but also offer greater flexibility in terms of speed adjustment and energy efficiency.

### SUMMARY

One example is a method of controlling an electric motor, the method comprising: calculating, by a motor controller, setpoint Q-D signals based on a setpoint speed signal, the setpoint Q-D signals represent setpoint position of a magnetic field relative to a rotor of the electric motor; serially sending, by the motor controller, the setpoint Q-D signals to a field-oriented controller disposed within a distinct packaging from the motor controller; converting, by the field-oriented controller, the setpoint Q-D signals to setpoint α-β signals that represent setpoint position of the magnetic field relative to A stator of the electric motor; transforming, by the field-oriented controller, the setpoint α-β signals into setpoint voltage signals; and gating, by the field-oriented controller, an inverter based on the setpoint voltage signals.

In the example method, serially communicating the setpoint Q-D signals may comprise sending at one megabit per second or less.

The example method may further comprise: serially receiving, by the motor controller, a measured speed signal and measured Q-D signals, the measured Q-D signals represent position of a magnetic field relative to a rotor of the electric motor; wherein calculating the setpoint Q-D signals further comprises calculating based on the setpoint speed signal, the measured speed signal, and the measured Q-D signals. Serially sending the setpoint Q-D signals may comprise sending at one megabit per second or less, and wherein serially receiving the measured speed signal and measured Q-D signals may comprise receiving at one megabit per second or less. Serially receiving may comprise receiving the setpoint speed signal, the measured speed signal, and the measured Q-D signals by serial communication at one megabit per second or less.

The example method may further comprise, by the field-oriented controller: receiving current signals from current sensors associated with the electric motor; converting the current signals into measured α-β signals that represent position of the magnetic field relative to the stator of the electric motor; receiving a position indication from a position sensor coupled to the electric motor, and creating a position signal and a measured speed signal from the position indication; converting the measured α-β signals and the position signal into measured Q-D signals that represent measured position of the magnetic field relative to the rotor of the electric motor; and serially sending the measured Q-D signals and the measured speed signal to the motor controller. Calculating the setpoint Q-D signals may further comprise calculating based on the setpoint speed signal, the measured speed signal, and the measured Q-D signals. The example method may further comprise providing measured α-β signals and position signal synchronously with the position signal to the converting into the measured Q-D signals. The example method may further comprise, by the field-oriented controller: measuring temperature of a semiconductor substrate to create a measured temperature; and delaying propagation of the measured α-β signals based on the measured temperature to compensate for processing delay in creating the position signal.

Another example is a packaged semiconductor product, comprising: a position-sense terminal, current-sense terminals, a serial-bus terminal, and gate terminals; a position-sensor interface coupled to the position-sense terminal, the position-sensor interface configured to generate a position signal and a speed signal; a current-sensor interface coupled to the current-sense terminals, the current-sensor interface configured to generate current-sense signals; a reference-frame converter coupled to the current-sense signals and the position signal, the reference-frame converter configured to transform a multiphase current reference frame of an electric motor to measured Q-D signals that represent position of a magnetic field relative to a rotor of the electric motor; a communications interface coupled to the serial-bus terminal, the speed signal, and the measured Q-D signals, the communications interface configured to serially transmit the speed signal and the measured Q-D signals to a motor controller by way of the serial-bus terminal; the communications interface may be further configured to receive, by way of the serial-bus terminal, setpoint Q-D signals; an inverse reference-frame converter coupled to the setpoint Q-D signals, the inverse reference-frame converter configured to transform the setpoint Q-D signals into setpoint signals for a plurality of phases of the electric motor; and a PWM generator coupled to the setpoint signals and configured to drive gate signals to the gate terminals.

In the example packaged semiconductor product, the communications interface may be configured to serially transmit the speed signal and the measured Q-D signals at one megabit per second or less.

In the example packaged semiconductor product, the communications interface may be configured to serially receive the setpoint Q-D signals at one megabit per second or less.

In the example packaged semiconductor product, the reference-frame converter may comprise: a Clarke converter coupled to the current-sense signals and configured to generate measured α-β signals that represent position of a magnetic field relative to a stator of the electric motor; and a Park converter coupled to the position signal and the measured α-β signals, the Park converter configured to generate the measured Q-D signals. The inverse reference-frame converter may comprise: an inverse Park converter coupled to the setpoint Q-D signals, the inverse Park converter configured to generate setpoint α-β signals that represent setpoint position of the electric field relative to the stator; and an inverse Clarke converter coupled to the setpoint α-β signals and configured to generate the setpoint signals. The example packaged semiconductor product may further comprise a delay logic communicatively disposed between the Clarke converter and the Park converter, the delay logic configured to compensate for computational delay of the position-sensor interface. The example packaged semiconductor product may further comprise: a temperature sensor disposed within the packaged semiconductor product; a controllable delay logic coupled to the temperature sensor and communicatively disposed between the Clarke converter and the Park converter, the controllable delay logic configured to compensate for both static computational delay and temperature dependent computational delay of the of the position-sensor interface. The example packaged semiconductor product may further comprise a controllable delay logic communicatively disposed between the Clarke converter and the Park converter, the controllable delay logic configured to sense clocking frequency, and compensate for frequency-dependent computational delay of the of the position-sensor interface. The example packaged semiconductor product may further comprise: a temperature sensor disposed within the packaged semiconductor product; and a controllable delay logic coupled to the temperature sensor. The controllable delay logic communicatively disposed between the Clarke converter and the Park converter, the controllable delay logic may be configured to: compensate for static computational delay of the position-sensor interface; and compensate for temperature-dependent computation delay of the position-sensor interface.

In the example packaged semiconductor product the current-sensor interface may be configured to receive analog signals from the current-sense terminal, and generate the current-sense signals in digital format.

In the example packaged semiconductor product the position-sensor interface may be configured to receive analog signals from the position-sense terminal, and generate the position signals in digital format.

The example packaged semiconductor product may comprise a semiconductor substrate, and wherein the position-sensor interface, the current sensor, the reference-frame converter, the communications interface, the inverse reference-frame converter, and the PWM generator are all implemented on the semiconductor substrate.

### BRIEF DESCRIPTION OF THE DRAWINGS

For a detailed description of example embodiments, reference will now be made to the accompanying drawings in which:

FIG. 1 shows a block diagram of an example motor control system.

FIG. 2 shows a functional block diagram of the motor control system.

FIG. 3 shows a block diagram of an example a reference-frame converter.

FIG. 4 shows a block diagram of an example a reference-frame converter that implements controllable delay.

FIG. 5 shows a block diagram of an example motor control system.

FIGS. 6A and 6B show a method in accordance with at least some embodiments.

### DEFINITIONS

Various terms are used to refer to particular system components. Different companies may refer to a component by different names-this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions. To be clear, an initial reference to “a [referent]”, and then a later reference for antecedent basis purposes to “the [referent]”, shall not obviate the fact the recited referent may be plural.

The terms “input” and “output,” when used as nouns, refer to connections and shall not be read as verbs requiring action. For example, a position-sensor circuit may define a position output. The position output may be multi-bit digital word that represents positon of a rotor an electric motor. In systems implemented directly in hardware (e.g., on a semiconductor substrate), these “inputs” and “outputs” define electrical connections.

“Signal” or “signals” shall mean any form of transmitted or received data that conveys information. “Signal” thus encompasses both analog signals, which are continuous waveforms that vary over time, and multi-bit digital words that are discrete, quantized representations of data composed of multiple binary digits (bits) that encode information in a structured format.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various examples are directed to electric motor controllers and related methods. More particularly, various examples are directed to a field-oriented controller as a packaged semiconductor product. The field-oriented controller implements the “high speed” aspects of motor control, such Clarke Transforms and Park Transforms, and leaves to other, external devices to implement user-programmable and/or “low speed” aspects of motor control, such as the proportional-integral-differential (PID) control loops. In this way, the field-oriented controller is usable with multiple different front-end control preferences, usable with different controlled parameter implementations (e.g., speed, position, torque), and also usable with a range of electric motors types, such as brushless DC and three-phase AC motors (e.g., induction motors and synchronous motors). The specification now turns to an example implementation.

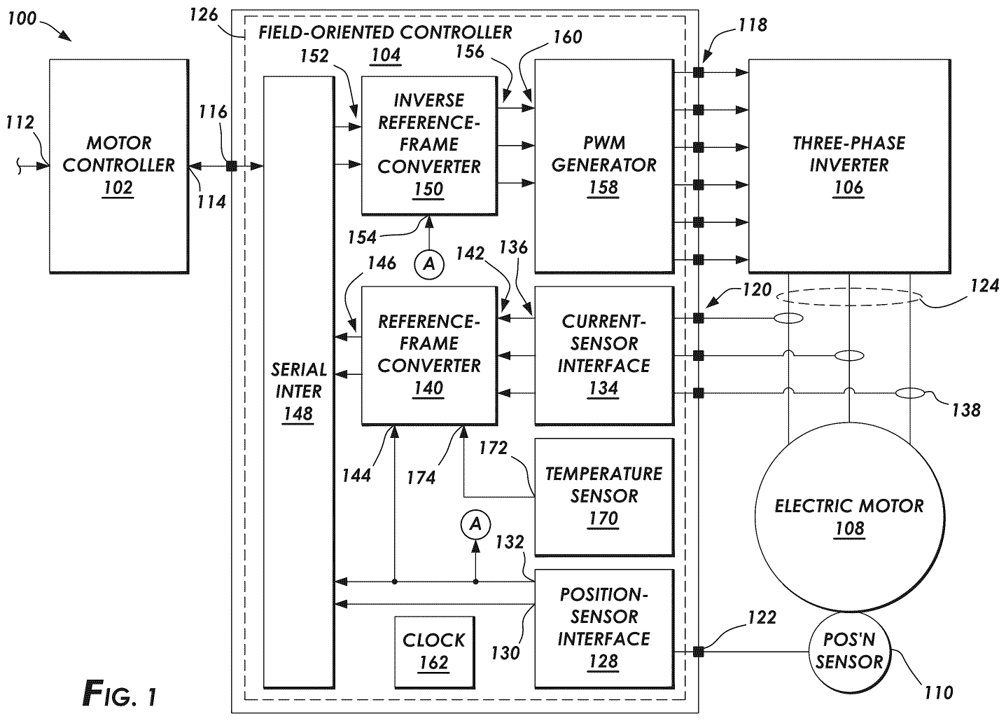

FIG. 1 shows, in block diagram form, an example motor control system 100. In particular, the example motor control system 100 comprises a motor controller 102, a field-oriented controller 104, a three-phase inverter 106, an electric motor 108, and a position sensor 110. The example motor controller 102 defines a setpoint input 112 and a serial bus connection 114. The example motor controller 102 receives a setpoint signal by way the setpoint input 112, and also receives a measured signal by way of the serial bus connection 114. The motor controller 102 makes various user-specific calculations, such as user-specific proportional-integral-differential control loop(s), and communicates control values to the field-oriented controller 104 by way of the serial bus connection 114. The various control values communicated are discussed in greater detail below after introduction of reference frame converters in the field-oriented controller 104. The serial bus protocol, and thus the precise electrical arrangement of the serial bus, may implement any suitable bidirectional serial bus communication scheme, such as an Inter-Integrated Circuit (I2C) protocol or a Serial Peripheral Interface (SPI) protocol. The motor controller 102 may control based on any controllable parameter of the motor, such as speed, motor position, or torque, and combinations. Thus, the setpoint input may be a speed setpoint, a position setpoint, or a torque setpoint. Similarly, the measured signal may be speed, motor position, or torque. The various embodiments were developed in the context of a system controlling motor speed, and the specification that follows is based on the developmental context; however, the developmental context of speed control shall not be read as a limitation of the applicability of the various examples.

The example field-oriented controller 104 is a packaged semiconductor product with various pins or terminals electrically accessible on the outside of the packaging. The example field-oriented controller 104 defines a serial-bus terminal 116, a set of gate terminals 118 (e.g., six), a set of current-sense terminals 120 (e.g., three), and a set of position-sense terminals 122 (e.g., five). Additional terminals will be present, such as power and ground terminals, but the additional terminals are not shown so as not to unduly complication the discussion. While only one serial-bus terminal 116 is shown, two or more may be present depending upon the serial communication protocol implemented between the motor controller 102 and the field-oriented controller 104. Similarly for the set of position-sense terminals 122, while only one position-sense terminal is shown, two or more position sense terminals may be implemented to accommodate multiple types of position sensors 110.

The set of gate terminals 118 is coupled to the three-phase inverter 106. In particular, the three-phase inverter 106 is provided gate signals from the field-oriented controller 104, and the three-phase inverter 106 uses the gate signals to provide voltage and current to the electric motor 108 through motor leads 124. Stated otherwise, the three-phase inverter 106 receives the on/off signals and turns on or off the high side and low side electrically-controlled switches, such as field-effect transistors (FETs). Thus, the gate signals provided from the field-oriented controller 104 control the conductive state of the FETs to provide three-phase voltage and current to the electric motor 108. Though the example motor control system 100 of FIG. 1 shows the field-oriented controller 104 directly coupled to the three-phase inverter 106, in other cases one or more gate driver circuits may reside between the field-oriented controller 104 and the three-phase inverter 106. That is, the field-oriented controller 104 may provide gate signals that are Boolean, but the field-oriented controller 104 may not be designed and constructed to drive sufficient voltage and current to control the gate of the power semiconductor FETs within the three-phase inverter 106. The gate driver circuits may be selected based on the voltage and current requirements of the electrically-controlled switches.

Still referring to FIG. 1, the example motor control system 100 comprises the electric motor 108 and attached position sensor 110. The electrical motor 108 may take any suitable form, such as an AC synchronous motor, an AC induction motor, or a brushless DC motor (which is driven similarly to its AC counterparts). The various embodiments were developed in the context of the electric motor 108 being a brushless DC motor, and the description that follows is based on the developmental context. However, one having ordinary skill, and with the benefit of this disclosure, could apply the teachings of the field-oriented controller 104 to many different types of electrical motors. Though not specifically shown in FIG. 1, the electric motor 108 has a rotating portion or rotor, and a stationary portion or stator. The voltage and current applied by way of the motor leads 124 to the stator creates a rotating magnetic field. A magnetic field of the rotor is attracted to the rotating magnetic field of the stator, causing the rotor to turn.

The position sensor 110 measures or senses the physical position of the rotor. Any suitable position sensor 110 technology may be used, such as Hall Effect Sensors, an optical or magnetic encoder, or a resolver that uses a rotating transformer. Regardless, data related to the instantaneous rotational position of the rotor is provided to the field-oriented controller 104 by way of the set of position-sense terminals 122.

Still referring to FIG. 1, and now specifically to the internal components of the field-oriented controller 104. In example cases, the functionality of the field-oriented controller 104 is implemented on a single semiconductor die or semiconductor substrate 126. That is, at the semiconductor processing stage, many such field-oriented controllers may be simultaneously constructed on a semiconductor wafer. After fabrication is complete, the various device are cut or singulated. Each singulated die is then packaged as a semiconductor product, with the various electrical connections on the die (e.g., bond pads) electrically coupled to the externally accessible terminals.

Starting at the bottom-right, the example field-oriented controller 104 comprises a position-sensor interface 128 coupled to the set of position-sense terminals 122. The position-sensor interface 128 defines a speed output 130 and a position output 132. The position-sensor interface 128 is designed and constructed to generate speed signals driven to the speed output 130, and to generate position signals driven to the position output 132. In some implementations, the rotor of the electric motor 108 may be turning at 10,000 revolutions per minute (RPM) or more. In order for the other components of the field-oriented controller 104 to correctly utilize the position signals, the position-sensor interface 128 may sample and drive an updated position signals at the Nyquist rate or faster taking into account the speed of the rotor. In one example implementation, the position-sensor interface 128 samples the position at a frequency of about one mega-Hertz, and each sample produces a multibit word of 20 bits representing position.

The example field-oriented controller 104 further defines a current-sensor interface 134 coupled to the set of current-sense terminals 120, and the current-sensor interface defines a set of current-sense outputs 136. The current-sensor interface 134 is designed and constructed to read indications of the phase currents on the motor leads 124, and to generate a set of current-sense signals, one signal each for each of the motor leads 124. In the example of FIG. 1, the individual phase currents of the motor leads 124 are sampled by current transformers, such as current transformer 138. However, any suitable current sensing technology may be used, such as Hall Effect sensing and current sense resistors. In order for the other components of the field-oriented controller 104 to correctly utilize the set of current-sense signals, the current-sensor interface 134 may sample and drive an updated position signals at the Nyquist rate or faster relative to the frequency of the signals applied to the electric motor 108. In one example implementation, the current-sensor interface 134 samples the phase currents at 100,000 samples per second, and each sample produces a multibit word of 16 bits representing instantaneous current.

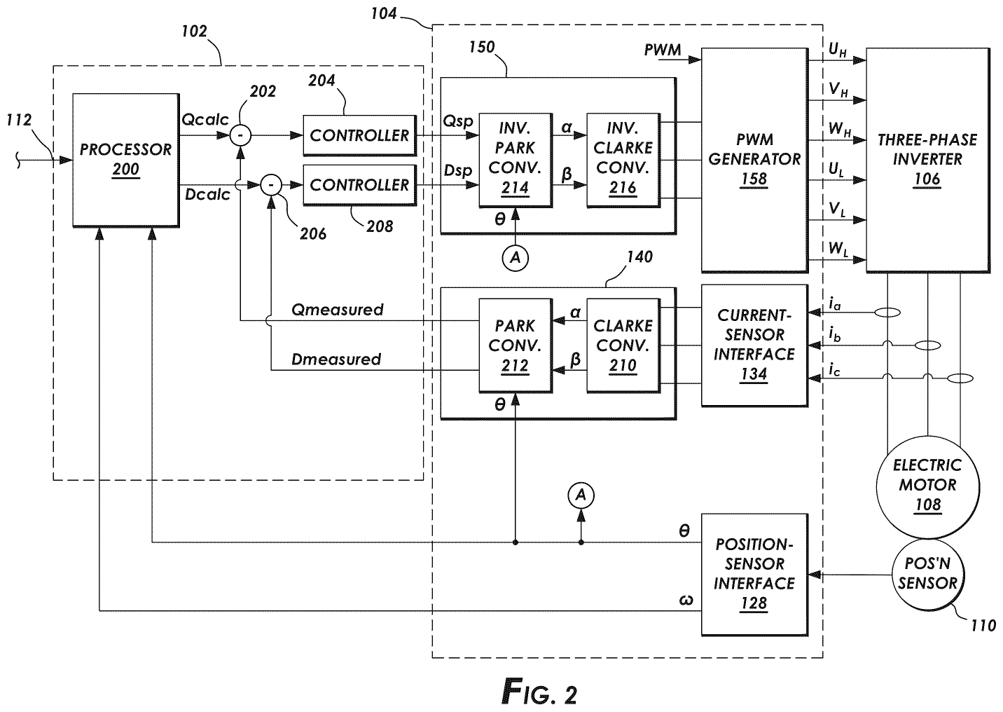

Still referring to FIG. 1, the example field-oriented controller 104 further comprises a reference-frame converter 140. The reference-frame converter 140 defines a set of current-sense inputs 142 coupled to the set of current-sense outputs 136, a position input 144 coupled to the position output 132, and Q-D outputs 146. The reference-frame converter 140 receives the position signals from the position-sensor interface 128, and receives current-sense signals from the current-sensor interface 134. The reference-frame converter 140 is designed and constructed to transform the multiphase current reference frame of the electric motor 108 to measured Q-D signals that represent position of the magnetic field of the stator relative to the rotor of the electric motor. The reference-frame converter 140 is explained in greater detail below in reference to FIG. 2.

The example field-oriented controller 104 further includes a communications interface 148 (labeled “Serial Inter” in the figure) coupled to the serial-bus terminal 116, the Q-D outputs 146, the speed output 130, and the position output 132. Thus, the communications interface 148 receives the speed signals and/or the position signals from the position-sensor interface 128, and receives the measured Q-D signals from the reference-frame converter 140. The communications interface 148 is designed and constructed to serially transmit the speed signals and/or the position signals, along with the measured Q-D signals, to the motor controller 102 by way of the serial-bus terminal 116. The communications interface 148 is further configured to receive, by way of the serial-bus terminal 116, setpoint Q-D signals from the motor controller 102. In the example method, serially communicating the setpoint Q-D signals may comprise sending at one megabit per second or less.

The example communications interface 148 communicates at relatively low speed compared to the “high speed” calculations within the field-orientated controller 104. For example, the communications interface 148 may send data, such as the measured speed signal, the measured position signal, and the measured Q-D signals, at one megabit per second or less. Similarly, the communications interface 148 may receive data from the motor controller 102, such as the setpoint Q-D signals, at one megabit per second or less. Given that the position-sensor interface 128 samples the position at a frequency of about one mega-Hertz, and each sample produces a multibit word of 20 bits representing position, not all of the position signals can be communicated across the communications interface 148.

The example field-oriented controller 104 further comprises an inverse reference-frame converter 150. The inverse reference-frame converter 150 defines setpoint Q-D inputs 152 coupled to the communications interface 148, a position input 154 coupled to the position output 132 (as shown by bubble “A”), and a set of setpoint-voltage outputs 156. The inverse reference-frame converter 150 receives setpoint Q-D signals from the motor controller 102 (by way of the communications interface 148), and position signals from the position-sensor interface 128. The inverse reference-frame converter 150 is designed and constructed to transform the setpoint Q-D signals into setpoint-voltage signals for a plurality of phases of the electric motor 108. The inverse reference-frame converter 150 is explained in greater detail below in reference to FIG. 2.

Still referring to FIG. 1, the example field-oriented controller 104 further comprises a pulse-width modulation generator, hereafter just PWM generator 158. The PWM generator 158 defines a set of setpoint-voltage inputs 160, and the PWM generator 158 is coupled to the set of gate terminals 118. The PWM generator 158 is designed and constructed to drive gate signals to the set of gate terminals 118, which in turn cause the three-phase inverter 106 to drive currents to the electric motor 108.

The field-oriented controller 104 further comprises a clock circuit 162. The clock circuit 162 is shown unconnected; however, the clock circuit 162 may be connected to all the various functional blocks of the field-oriented controller 104, but those connections are not shown so as not to unduly complicate the figure. The clock signal provided by the clock circuit 162 may have a frequency of between and including 30 and 60 MHz. The functions of the reference-frame converter 140 and inverse reference-frame converter 150 are implemented digitally as a hardware-based system or hardware logic. That is, the calculations are performed based on digital words, such as in combination logic and/or sequential logic. With the exception of the analog aspects of the position-sensor interface 128 and the current-sensor interface 134, those functions too are implemented as hardware logic. Thus, the field-oriented controller 104 may be an application-specific integrated circuit that does not include a processor or micro-processor executing software.

FIG. 2 shows a functional block diagram of the motor control system 100. In particular, FIG. 2 shows in more detail the motor controller 102 and the field-oriented controller 104. Turning first to the motor controller 102, the example motor controller 102 comprises a processor 200, a Q-error block 202, a Q controller 204, a D-error block 206, and a D controller 208. The processor 200 is communicatively coupled to the setpoint input 112. The processor 200 may be communicatively coupled to the speed signals from the position-sensor interface 128 and/or the position signals from the position-sensor interface 128. The processor 200 may implement user-specific calculations in generating calculated Q-D signals, labeled as Qcalc and Dcalc, respectively, in the figure. Each set of Qcalc and Dcalc signals are digital words; however, the Qcalc and Dcalc represent setpoint voltage values. While the processor 200 is shown directly coupled to the position-sensor interface 128, in practice the speed signals and/or position signals are provided to the processor 200 by way of the communications interface 148 (FIG. 1), but the communications interface is not shown in FIG. 2 so as not to further complicate the figure.

The Q-error block 202 is coupled to the Qcalc signal from the processor 200, and is coupled to measured Q signal (labeled Qmeasured in the figure) from the field-oriented controller 104. The Q-error block 202 is designed and constructed to calculate a Q-error signal applied to the Q controller 204. The Q controller 204, in turn, may implement any suitable closed loop control, such as a PID controller, and the Q controller 204 is designed and constructed to generate a setpoint Q value, labeled Qsp in the figure. While the Qmeasured signal is shown directly coupled to the Q-error block 202, and the Qsp signal is shown directly coupled to the field-oriented controller 104, in practice the signals are provided by way of the communications interface 148 (FIG. 1), but the communications interface is not shown in FIG. 2 so as not to further complicate the figure.

Similarly, the D-error block 206 is coupled to the Dcalc signal from the processor 200, and is coupled to measured D signal (labeled Dmeasured in the figure) from the field-oriented controller 104. The D-error block 206 is designed and constructed to calculate a D-error signal applied to the D controller 208. The D controller 208, in turn, may implement any suitable closed loop control, such as a PID controller, and the D controller 208 is designed and constructed to generate a setpoint D value, labeled Dsp in the figure. While the Dmeasured signal is shown directly coupled to the D-error block 206, and the Dsp signal is shown directly coupled to the field-oriented controller 104, in practice the signals are provided by way of the communications interface 148 (FIG. 1).

Still referring to FIG. 2, and turning now to the field-oriented controller 104. The field-oriented controller 104 comprises the position-sensor interface 128, the current-sensor interface 134, the reference-frame converter 140, the inverse reference-frame converter 150, and the PWM generator 158. The example reference-frame converter 140 comprises a Clarke converter 210 and a Park converter 212. The Clarke converter 210 is coupled to the current-sense signals from the current-sensor interface 134. The Clarke converter 210 is designed and constructed to generate measured α-β signals that represent position of the magnetic field of the stator relative to the stator 108. Stated otherwise, the Clarke converter 210 is designed and constructed to transform a multiphase current reference frame of the phase currents iₐ, i_{b}, and i_{c} into measured α-β signals having a stationary reference of the stator.

In the example of FIG. 2, the Park converter 212 is coupled to the position signal from the position-sensor interface 128 and the measured α-β signals from the Clarke converter 210. The example Park converter 212 is designed and constructed to generate the measured Q-D signals based on the position signals and the measured α-β signals. Stated otherwise, the Park converter 212 is designed and constructed to transform the measured α-β signals, expressed in the stationary reference of the stator, to the measured Q-D signals that represent position of the magnetic field of the stator relative to the magnetic field of the rotor. Each Qmeasured signal can be thought of as an indication of the amount of instantaneous torque provided by the electrical motor 108, and Qmeasured is sometimes referred to as “quadrature current.” The Dmeasured signal can be thought of as an indication of the amount of instantaneous magnetization current, and Dmeasured is sometimes referred to as “direct current” or “magnetization current.” For brushless DC motors, the magnetization current is controlled to be near zero, but for other electric motors, such as induction motors, non-zero magnetization current may be used.

Still referring to FIG. 2, and now turning to the inverse reference-frame converter 150. The example inverse reference-frame converter 150 comprises an inverse Park converter 214 and an inverse Clarke converter 216. The inverse Park converter 214 is coupled to the position signals from the position-sensor interface 128 and the setpoint Q-D signals from the motor controller 102. The inverse Park converter 214 is designed and constructed to generate setpoint α-β signals that represent setpoint position of the voltages applied to the stator relative to the stator. Stated otherwise, the inverse Park converter 214 is designed and constructed to transform the setpoint Q-D signals, expressed in the rotating reference of the rotor, to the setpoint α-β signals that represent position of the magnetic field relative to the stator.

The inverse Clarke converter 216 is coupled to the setpoint α-β signals. The inverse Clarke converter 216 is designed and constructed to generate the setpoint voltage signals applied to the PWM generator 158. Stated otherwise, the inverse Clarke converter 216 is designed and constructed to transform the setpoint α-β signals, expressed in the stationary reference frame of the rotor, into setpoint phase voltages to be applied to the stator.

In various examples, the functions of the Clarke converter 210, the Park converter 212, the inverse Park converter 214, and the inverse Clark converter 216 are implemented digitally as a hardware-based system or hardware logic. That is, the calculations are performed based on digital words, such as in combination logic and/or sequential logic. With the exception of the analog aspects of the position-sensor interface 128 and the current-sensor interface 134, those functions too are implemented as hardware logic. Having the various functions implemented as hardware logic enables characterization of the field-oriented controller 104, and direct hardware compensation for the delays and/or differences in processing speed for each of the functions. For example, the Park converter 212 provides higher accuracy measured Q-D signals when the instantaneous position signal provided from the position-sensor interface 128 is aligned in time with the measured α-β signals provided from the Clarke converter 210. Stated otherwise, higher accuracy measured Q-D signals are created when the position signal from the position-sensor interface 128 is synchronous with the corresponding measured α-β signal. However, the position-sensor interface 128 may have a longer computation time (e.g., takes more clock cycles) than the computation time of the combined current-sensor interface 134 and Clarke converter 210. Some example field-oriented controllers 104 compensate differences in computational time by slowing down or delaying delivery of the measured α-β signals to the Park converter 212.

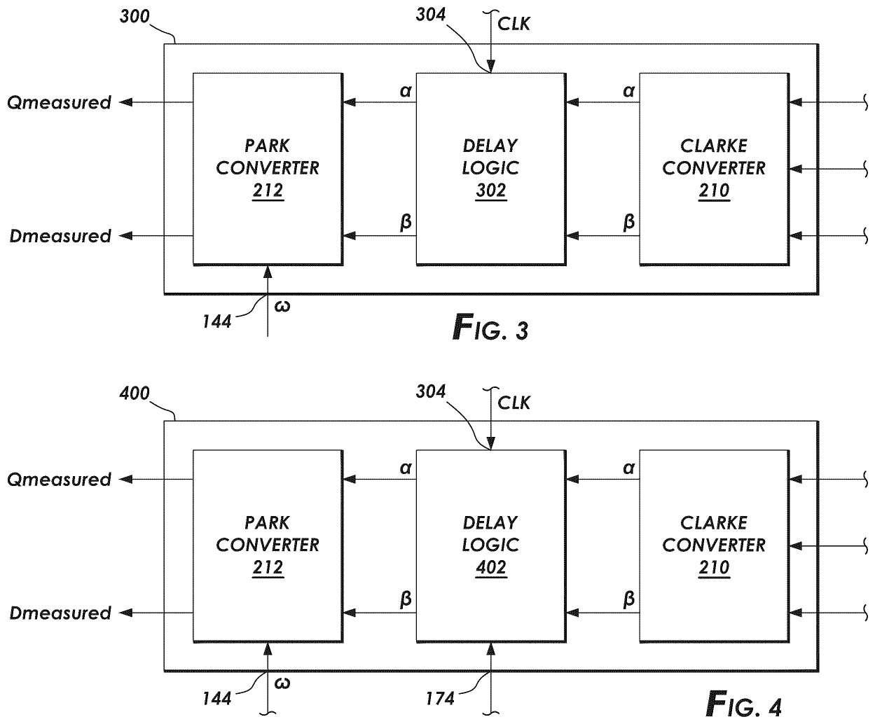

FIG. 3 shows a block diagram of an example of reference frame converter 300. In particular, the reference frame converter 300 comprises the Clarke converter 210 and the Park converter 212, and also comprises a delay logic 302 communicatively disposed between the Clarke converter 210 and the Park converter 212. The delay logic 302 receives the measured α-β signals from the Clarke converter 210, and implements a propagation delay for each set of values. Stated otherwise, the example delay logic 302 provides a fixed and predetermined delay in communicating the measured α-β signals to the Park converter 212. The delay at least partially compensates for computational delay of the position-sensor interface 128 (FIG. 1). The delay logic 302 may take any suitable form, such as shift register-based delay circuits or a fixed set of first-in first-out buffers.

The amount of delay implemented by the delay logic 302 may be determined in many ways. In one example, at the design stage the expected computational delay of the position-sensor interface 128 may be compared to the expected computational delay of the current-sensor interface 134 and the Clarke converter 210. Based on the differences in computational delay, the delay logic 302 may be designed to provide the predetermined delay.

However, the computational delay of the position-sensor interface 128 (FIG. 1) may vary from die-to-die even on the same semiconductor wafer. Thus, in other cases the computational delay may be measured on the semiconductor wafer after the construction (e.g., at the “probe” stage), and then a more precise delay may be implemented within the delay logic 302, such as by laser removal of delay elements to more precisely control the delay on each die. In other examples, the delay logic 302 may implement a controllable delay based on operating parameters of the field-oriented controller 104. For example, the delay logic 302 may sense the clock frequency by way of a clock input 304, and compensate for frequency-dependent computational delay of the position-sensor interface 128. Stated otherwise, the example delay logic 302 may implement a delay comprising a “static” computational delay and a frequency-dependent computational delay.

Returning briefly to FIG. 1, the example field-oriented controller 104 may comprise a temperature sensor 170 disposed within the packaging, and in some cases disposed on the semiconductor substrate 126. The temperature sensor 170 may be designed and constructed to determine a temperature of the semiconductor substrate 126, and produce a temperature signal driven to a temperature output 172. Creating the temperature signal may take any suitable form. In one example, analog-based measurements (e.g., resistive temperature measurement) are converted into digital form and driven to the temperature output 172. In other cases, the temperature signal may be calculated digitally, such as based on an amount of time for a signal to propagate along a logic chain whose speed of propagation is temperature dependent. The example reference-frame converter 140 further includes a temperature input 174. In various examples, the reference-frame converter 140 uses the temperature signals to implement variable delay.

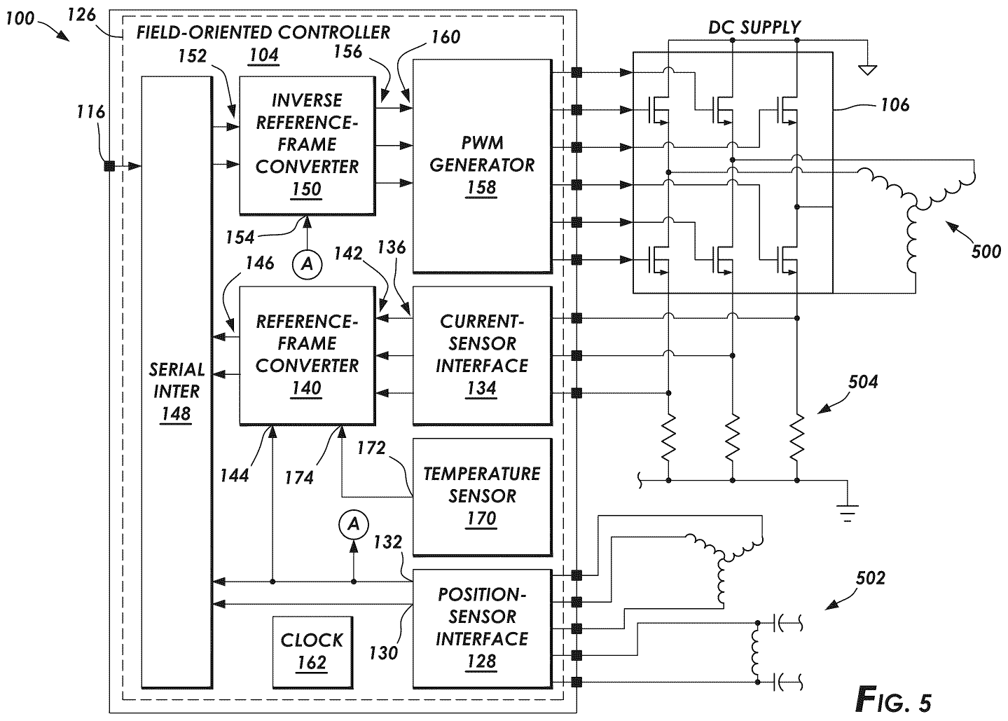

FIG. 4 shows a block diagram of an example reference-frame converter 400 that implements controllable delay based on temperature. In particular, the reference-frame converter 400 comprises the Clarke converter 210 and the Park converter 212, and also comprises a delay logic 402 communicatively disposed between the Clarke converter 210 and the Park converter 212. The delay logic 402 receives the measured α-β signals from the Clarke converter 210, and implements a propagation delay for each set of values. More particularly, the example delay logic 402 receives temperature signals by way of the temperature input 174, and the example delay logic 402 implements a controllable delay based on the temperature signals to compensate for temperature-dependent computation delay of the position-sensor interface 128 (FIG. 1). Stated otherwise, the example delay logic 402 may compensate for both the “static” computational delay of the position-sensor interface 128 and temperature-dependent computation delay of the position-sensor interface 128. In yet still further cases, the example delay logic 402 may compensate for static computational delay of the position-sensor interface 128, temperature-dependent computation delay of the position-sensor interface 128, and frequency-dependent computational delay of the of the position-sensor interface 128.

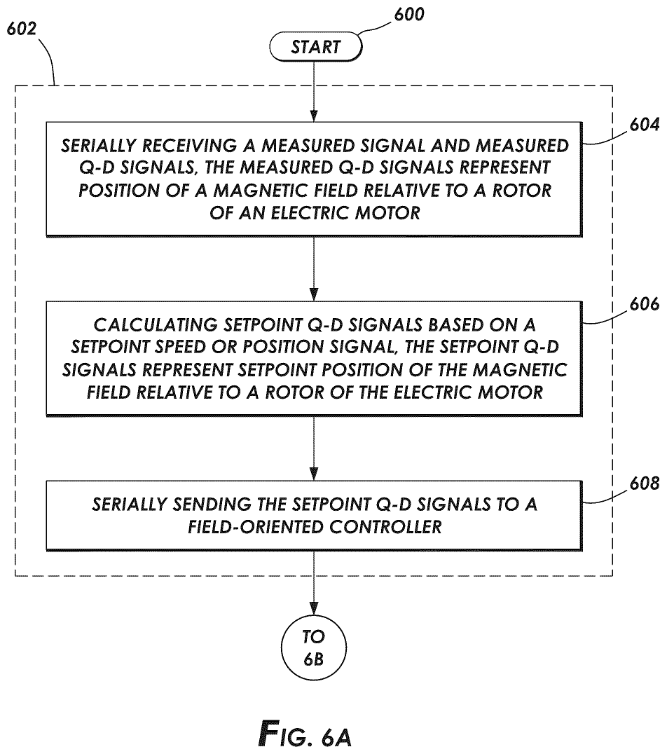

FIG. 5 shows a block diagram of an example motor control system 100. In particular, FIG. 5 shows the field-oriented controller 104 from FIG. 1, along with a three-phase inverter 106, stator windings 500, and an inductive rotor-position sensor 502. The example three-phase inverter 106 comprises six FETs. The upper FETS have their drains coupled to a DC supply, while the lower FETs have their sources coupled to a reference voltage, such as ground. The sources of the upper FETS and the drains of the lower FETs define respective switch nodes coupled to respected leads of the stator windings 500. More particularly, the example stator 500 is a three-phase stator connected in a “Y” configuration, thus defining three stator leads. Each stator lead is associated with a set of FETs comprising an upper FET and a lower FET within the three-phase inverter 106. Thus, the field-oriented controller 104 gates (e.g., PWM) the three-phase inverter 106 and thereby supplies voltage and current to the stator windings 500 to create a magnetic field that rotates with respect to the stator windings.

In the example of FIG. 5, the current sensors used to sense phase currents are current-sense resistors 504 associated one each with motor lead. The example current-sensor interface 134 is thus designed and constructed to sense voltage across each of the current-sense resistors, and convert the sensed voltages into the sensed current signals discussed above. Again, the field-effect controller 104 may interface with other, different types of current sensors, such as Hall Effect sensors.

Finally, the example field-oriented controller 104, and specifically the position-sensor interface 128, is shown coupled to a position sensor in the form of an inductive rotor-position sensor 502. In this example, the field-oriented controller thus implements five terminals coupled to the position-sensor interface 128. In particular, the example position-sensor interface 128 may sense rotor position based on analog signals from the inductive rotor-position sensor 502, and create the position signals and speed signals based thereon.

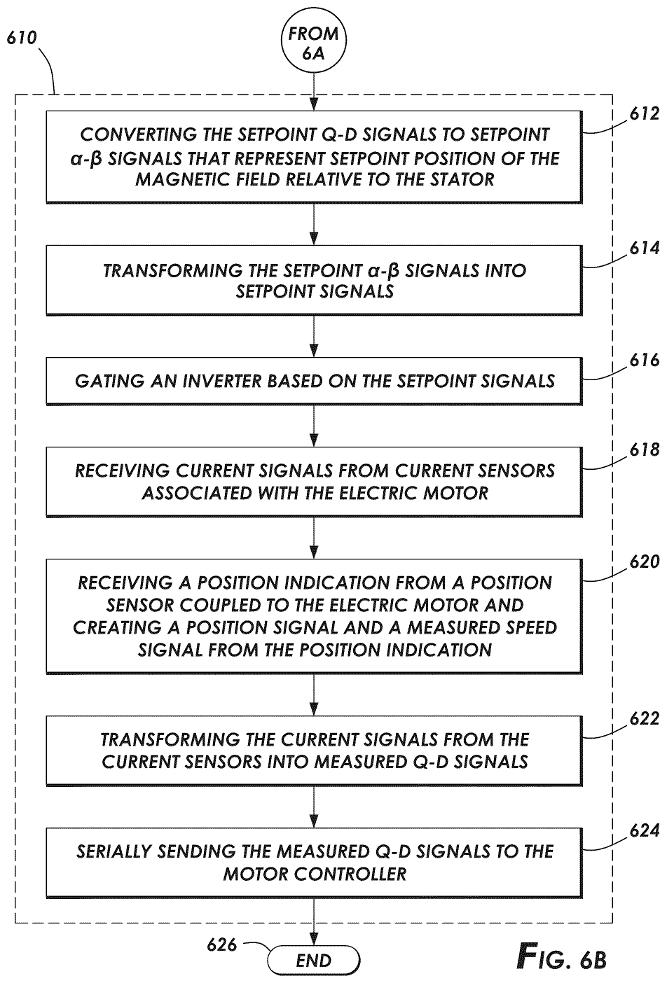

FIGS. 6A and 6B show a method in accordance with at least some embodiments. In particular, the method starts (block 600) and comprises steps implemented within the motor controller, as shown by dashed box 602. The example motor controller serially receives a measured signal and measured Q-D signals, with the measured Q-D signals representing position of a magnetic field relative to a rotor of an electric motor (block 604). The measured signal could be the measured speed signal, the measured position signal, or both. The motor controller calculates setpoint Q-D signals based on a setpoint speed or position signal, with the setpoint Q-D signals representing setpoint position of a magnetic field of a stator relative to a rotor of the electric motor (block 606). The motor controller may then serially send the setpoint Q-D signals to a field-oriented controller disposed within a distinct packaging from the motor controller (block 608).

Turning now to the method steps associated with the field-oriented controller, as shown in FIG. 6B within dashed box 610. The method may further comprise the field-oriented controller converting the setpoint Q-D signals to setpoint α-β signals that represent setpoint position of the magnetic field of the stator relative to the stator (block 612). The field-oriented controller may thereafter transform the setpoint α-β signals into setpoint signals (block 614). The field-oriented controller then gates the inverter based on the setpoint current signals (block 616). The field-oriented controller receives current signals from current sensors associated with the electric motor (block 618). The field-oriented controller receives a position indication from a position sensor coupled to the electric motor, and creates a position signal and a measured speed signal from the position indications (block 620). The field-oriented controller may then transform the current signals from the current sensors into measured Q-D signals (block 622), and serially send the measured Q-D signals to the motor controller (block 624). Thereafter, the method ends (block 626) to be repeated continually during operation of the electric motor.

The example field-oriented controller 104 thus implements the “high speed” aspects of motor control, such Clarke Transforms and Park Transforms, and leaves to other, external devices to implement user-programmable and “low speed” aspects of motor control, such as the proportional-integral-differential (PID) control loops. In this way, the field-oriented controller is usable with multiple different front-end control preferences, and is also usable with a range of electric motors types, such as brushless DC and three-phase AC motors (e.g., induction motors and synchronous motors).

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method of controlling an electric motor, the method comprising:
calculating, by a motor controller, setpoint Q-D signals based on a setpoint speed signal, the setpoint Q-D signals represent setpoint position of a magnetic field relative to a rotor of the electric motor;
serially sending, by the motor controller, the setpoint Q-D signals to a field-oriented controller disposed within a distinct packaging from the motor controller;
converting, by the field-oriented controller, the setpoint Q-D signals to setpoint α-β signals that represent setpoint position of the magnetic field relative to a stator of the electric motor;
transforming, by the field-oriented controller, the setpoint α-β signals into setpoint voltage signals; and
gating, by the field-oriented controller, an inverter based on the setpoint voltage signals.

2. The method of claim 1 wherein serially communicating the setpoint Q-D signals comprises sending at one megabit per second or less.

3. The method of claim 1 further comprising:
serially receiving, by the motor controller, a measured speed signal and measured Q-D signals, the measured Q-D signals represent position of a magnetic field relative to a rotor of the electric motor;
wherein calculating the setpoint Q-D signals further comprises calculating based on the setpoint speed signal, the measured speed signal, and the measured Q-D signals.

4. The method of claim 3 wherein serially sending the setpoint Q-D signals comprises sending at one megabit per second or less, and wherein serially receiving the measured speed signal and measured Q-D signals comprises receiving at one megabit per second or less

5. The method of claim 3 wherein serially receiving comprises receiving the setpoint speed signal, the measured speed signal, and the measured Q-D signals by serial communication at one megabit per second or less.

6. The method of claim 1 further comprising, by the field-oriented controller:
receiving current signals from current sensors associated with the electric motor;
converting the current signals into measured α-β signals that represent position of the magnetic field relative to the stator of the electric motor;
receiving a position indication from a position sensor coupled to the electric motor, and creating a position signal and a measured speed signal from the position indication;
converting the measured α-β signals and the position signal into measured Q-D signals that represent measured position of the magnetic field relative to the rotor of the electric motor; and
serially sending the measured Q-D signals and the measured speed signal to the motor controller.

7. The method of claim 6 further comprising wherein calculating the setpoint Q-D signals further comprises calculating based on the setpoint speed signal, the measured speed signal, and the measured Q-D signals.

8. The method of claim 6 further comprising providing measured α-β signals and position signal synchronously with the position signal to the converting into the measured Q-D signals.

9. The method of claim 6 further comprising, by the field-oriented controller:
measuring temperature of a semiconductor substrate to create a measured temperature; and
delaying propagation of the measured α-β signals based on the measured temperature to compensate for processing delay in creating the position signal.

10. A packaged semiconductor product, comprising:
a position-sense terminal, current-sense terminals, a serial-bus terminal, and gate terminals;
a position-sensor interface coupled to the position-sense terminal, the position-sensor interface configured to generate a position signal and a speed signal;
a current-sensor interface coupled to the current-sense terminals, the current-sensor interface configured to generate current-sense signals;
a reference-frame converter coupled to the current-sense signals and the position signal, the reference-frame converter configured to transform a multiphase current reference frame of an electric motor to measured Q-D signals that represent position of a magnetic field relative to a rotor of the electric motor;
a communications interface coupled to the serial-bus terminal, the speed signal, and the measured Q-D signals, the communications interface configured to serially transmit the speed signal and the measured Q-D signals to a motor controller by way of the serial-bus terminal;
the communications interface further configured to receive, by way of the serial-bus terminal, setpoint Q-D signals;
an inverse reference-frame converter coupled to the setpoint Q-D signals, the inverse reference-frame converter configured to transform the setpoint Q-D signals into setpoint signals for a plurality of phases of the electric motor; and
a PWM generator coupled to the setpoint signals and configured to drive gate signals to the gate terminals.

11. The packaged semiconductor product of claim 10 wherein the communications interface is configured to serially transmit the speed signal and the measured Q-D signals at one megabit per second or less.

12. The packaged semiconductor product of claim 10 wherein the communications interface is configured to serially receive the setpoint Q-D signals at one megabit per second or less.

13. The packaged semiconductor product of claim 10:
wherein the reference-frame converter comprises:
a Clarke converter coupled to the current-sense signals and configured to generate measured α-β signals that represent position of a magnetic field relative to a stator of the electric motor; and
a Park converter coupled to the position signal and the measured α-β signals, the Park converter configured to generate the measured Q-D signals;
wherein the inverse reference-frame converter comprises:
an inverse Park converter coupled to the setpoint Q-D signals, the inverse Park converter configured to generate setpoint α-β signals that represent setpoint position of the magnetic field relative to the stator; and
an inverse Clarke converter coupled to the setpoint α-β signals and configured to generate the setpoint signals.

14. The packaged semiconductor product of claim 13 further comprising a delay logic communicatively disposed between the Clarke converter and the Park converter, the delay logic configured to compensate for computational delay of the position-sensor interface.

15. The packaged semiconductor product of claim 13 further comprising:
a temperature sensor disposed within the packaged semiconductor product;
a controllable delay logic coupled to the temperature sensor and communicatively disposed between the Clarke converter and the Park converter, the controllable delay logic configured to compensate for both static computational delay and temperature dependent computational delay of the of the position-sensor interface.

16. The packaged semiconductor product of claim 13 further comprising a controllable delay logic communicatively disposed between the Clarke converter and the Park converter, the controllable delay logic configured to sense clocking frequency, and compensate for frequency-dependent computational delay of the of the position-sensor interface.

17. The packaged semiconductor product of claim 13 further comprising:
a temperature sensor disposed within the packaged semiconductor product;
a controllable delay logic coupled to the temperature sensor, and the controllable delay logic communicatively disposed between the Clarke converter and the Park converter, the controllable delay logic configured to:
compensate for static computational delay of the position-sensor interface; and
compensate for temperature-dependent computation delay of the position-sensor interface.

18. The packaged semiconductor product of claim 10 wherein the current-sensor interface is configured to receive analog signals from the current-sense terminal, and generate the current-sense signals in digital format.

19. The packaged semiconductor product of claim 10 wherein the position-sensor interface is configured to receive analog signals from the position-sense terminal, and generate the position signals in digital format.

20. The packaged semiconductor product of claim 10 comprising a semiconductor substrate, and wherein the position-sensor interface, the current sensor, the reference-frame converter, the communications interface, the inverse reference-frame converter, and the PWM generator are all implemented on the semiconductor substrate.
